(19) United States
(12) Patent Application Publication
(10) Pub. No.: US 2013/0274225 A1
(43) Pub. Date: Oct. 17, 2013

(54) METHOD FOR MAKING A POLYSACCHARIDE DIALDEHYDE HAVING HIGH PURITY

(71) Applicant: Douglas J. Adelman, Wilmington, DE (US)

(72) Inventor: Douglas J. Adelman, Wilmington, DE (US)

(73) Assignee: ACTAMAX SURGICAL MATERIALS, LLC, Berkeley, CA (US)

(21) Appl. No.: 13/811,474

(22) PCT Filed: Jul. 19, 2011
(86) PCT No.: PCT/US11/44423

§ 371 Date: Apr. 12, 2013

Related U.S. Application Data
(60) Provisional application No. 61/365,453, filed on Jul. 19, 2010.

(51) Int. Cl. C08B 37/02

(52) U.S. Cl. CPC C08B 37/0021
USPC 514/59

(57) ABSTRACT

A method for making polysaccharide dialdehydes is disclosed, which uses a combination of precipitation and separation steps to purify the polysaccharide dialdehyde formed by oxidation of a polysaccharide with periodate. The method is simple, rapid, and provides a polysaccharide dialdehyde having very low levels of iodine-containing species and a low ash content. The polysaccharide dialdehyde is particularly suitable for preparing hydrogel adhesives for medical applications.

### CROSS-REFERENCE TO RELATED APPLICATION

This application claims priority to U.S. Provisional Patent Application Ser. No. 61/365,453, filed Jul. 19, 2010, the contents of which are hereby incorporated by reference in its entirety.

### FIELD OF THE INVENTION

The invention relates to the field of medical adhesives. More specifically, the invention relates to a method for making a polysaccharide dialdehyde in a highly pure form which is useful for the preparation of hydrogel adhesives for medical applications.

### BACKGROUND OF THE INVENTION

Tissue adhesives have many potential medical applications, including wound closure, supplementing or replacing sutures or staples in internal surgical procedures, adhesion of synthetic onlays or inlays to the cornea, drug delivery devices, and as anti-adhesion barriers to prevent post-surgical adhesions. Conventional tissue adhesives are generally not suitable for a wide range of adhesive applications. For example, cyanoacrylate-based adhesives have been used for topical wound closure, but the release of toxic degradation products limits their use for internal applications. Fibrin-based adhesives are slow curing, have poor mechanical strength, and pose a risk of viral infection. Additionally, fibrin-based adhesives do not bond covalently to the underlying tissue.

Several types of hydrogel tissue adhesives have been developed, which have improved adhesive and cohesive properties and are nontoxic. These hydrogels are generally formed by reacting a component having nucleophilic groups with a component having electrophilic groups, which are capable of reacting with the nucleophilic groups of the first component, to form a crosslinked network via covalent bonding. Polysaccharide dialdehydes have been used as the component having electrophilic groups for preparing these hydrogel adhesives because they are highly biocompatible and biodegradable (see for example, Kodokian et al., copending and commonly owned U.S. Patent Application Publication No. 2006/0078536, and Goldmann, U.S. Patent Application Publication No. 2005/0002893). The polysaccharide dialdehydes are typically formed by oxidation of the polysaccharide with periodate. For medical applications of these hydrogel adhesives, the amount of unreacted periodate and iodine-containing byproducts in the polysaccharide dialdehyde preparation must be reduced to low levels to prevent toxic effects. Consequently, the polysaccharide dialdehyde is typically purified by extensive dialysis to remove the iodine containing species. However, dialysis is a slow process requiring many days and therefore, is not well suited to the large scale production of polysaccharide dialdehydes. Alternatively, iodate may be separated from dextran dialdehyde, prepared by the oxidation of dextran with periodate, using an ion exchange resin.

Cohen et al. (copending and commonly owned International Patent Application No. PCT/US08/05013 (WO 2008/133847)) describe a method for making a polysaccharide dialdehyde having high purity. That method comprises a combination of precipitation and separation steps to purify the oxidized polysaccharide formed by oxidation of the polysaccharide with periodate and provides an oxidized polysaccharide with very low levels of iodine-containing species. However, that method results in a gummy, rubbery product which is difficult to process on a large scale.

Therefore, the need exists for a method for making polysaccharide dialdehydes that is suitable for large scale production and provides a product that has a low level of iodine-containing species.

### SUMMARY OF THE INVENTION

The stated need is addressed herein by the discovery of an improved method for making polysaccharide dialdehydes which comprises a combination of precipitation and separation steps to purify the polysaccharide dialdehyde formed by oxidation of the polysaccharide with periodate. The method provides a product that is easy to recover by filtration.

Accordingly, in one embodiment the invention provides a method for making a polysaccharide dialdehyde comprising the steps of:
a) reacting a polysaccharide with at least one periodate salt at a temperature above about 10° C. to produce a product comprising said polysaccharide dialdehyde, iodate in the form of at least one iodate salt, and optionally periodate in the form of at least one unreacted periodate salt;
b) optionally cooling the product of step (a) to a crystallization temperature below about 5° C. and maintaining the product at the crystallization temperature for a time sufficient to form a precipitate comprising at least one periodate salt, and a first supernatant fluid,
c) optionally separating at least a portion of the precipitate from the first supernatant fluid;
d) adding a source of at least one cation, which is capable of precipitating at least a portion of the iodate, to the product of (a) or the first supernatant fluid of (b) or (c) thereby forming a second precipitate comprising said at least one cation and iodate, and a second supernatant fluid that comprises the polysaccharide dialdehyde;
e) separating at least a portion of the second precipitate from the second supernatant fluid;
f) adding at least one iodide salt to the second supernatant fluid thereby forming a mixture comprising the polysaccharide dialdehyde and molecular iodine;
g) optionally filtering the mixture to obtain a filtrate;
h) adding the mixture of (f) or the filtrate of (g) to a solvent selected from the group consisting of acetone, methanol, isopropanol, ethanol, n-propanol and mixtures thereof at a temperature of about −16° C. to about 10° C. at a rate such that the temperature is maintained at about −16° C. to about 10° C., thereby forming a first phase comprising the polysaccharide dialdehyde and a second phase comprising the solvent and water;
i) separating at least a portion of the first phase from the second phase at a temperature of about −16° C. to about 10° C. to provide a separated polysaccharide dialdehyde;
j) dissolving the separated polysaccharide dialdehyde in an aqueous liquid to provide a polysaccharide dialdehyde solution;
k) adding the polysaccharide dialdehyde solution to a solvent selected from the group consisting of acetone, methanol, isopropanol, ethanol, n-propanol and mixtures thereof at a temperature of about −16° C. to about 10° C. at a rate such that the temperature is maintained at about −16° C. to about 10° C., thereby forming a first phase comprising a purified polysaccharide dialdehyde and a second phase comprising the solvent and water; and
l) separating at least a portion of the first phase from the second phase of (k) at a temperature of about −16° C. to about 10° C. to provide a separated purified polysaccharide dialdehyde.

### DETAILED DESCRIPTION OF THE INVENTION

Disclosed herein is an improved method for making polysaccharide dialdehydes, which uses a combination of precipitation and separation steps to purify the polysaccharide dialdehyde formed by oxidation of a polysaccharide with periodate. The method is simple, rapid, and provides a polysaccharide dialdehyde which is readily recovered by filtration. Additionally, the polysaccharide dialdehyde produced by the method has very low levels of iodine-containing species, specifically, less than about 0.03 wt % (i.e., 300 ppm) elemental iodine, and other inorganic impurities, as evidenced by a low ash content, typically less than 0.6 wt %.

The low level of iodine-containing species and other inorganic impurities makes the polysaccharide dialdehydes particularly useful for preparing hydrogel adhesives for medical and veterinary applications, including, but not limited to, wound closure, supplementing or replacing sutures or staples in internal surgical procedures such as intestinal anastomosis and vascular anastomosis, tissue repair, ophthalmic procedures, drug delivery, and in anti-adhesive applications. Additionally, the resulting polysaccharide dialdehyde product has a higher bulk density than polysaccharide dialdehydes that are purified by dialysis and subsequently lyophilized. The higher bulk density facilitates the transportation and storage of the polysaccharide dialdehyde.

The following definitions are used herein and should be referred to for interpretation of the claims and the specification.

The terms “polysaccharide dialdehyde” and “oxidized polysaccharide” are used interchangeably herein to refer to a polysaccharide which has been reacted with periodate to introduce aldehyde groups into the molecule.

The terms “% by weight” and “wt %” as used herein refer to the weight percent of solute relative to the total weight of the solution.

The term “water-dispersible, multi-arm polyether amine” refers to a branched polyether, wherein at least three of the branches (“arms”) are terminated by at least one primary amine group, which is water soluble or able to be dispersed in water to form a colloidal suspension capable of reacting with a second reactant in aqueous solution or dispersion.

The term “polyether” refers to a polymer having the repeat unit [—O—R]—, wherein R is a hydrocarbylene group having 2 to 5 carbon atoms. The polyether may also be a random or block copolymer comprising different repeat units which contain different R groups.

The term “tissue” refers to any tissue, both living and dead, in humans or animals.

The term “hydrogel”, as used herein, refers to a water-swellable polymeric matrix, consisting of a three-dimensional network of macromolecules held together by covalent crosslinks, that can absorb a substantial amount of water to form an elastic gel.

By medical application is meant medical applications as related to humans and animals.

In the method disclosed herein, a polysaccharide is oxidized to produce a polysaccharide dialdehyde using periodate. The polysaccharide dialdehyde is then separated from excess periodate and iodine-containing byproducts and other inorganic impurities using a series of precipitation and separation steps, as described below.

Polysaccharides useful in the invention include, but are not limited to, dextran, starch, cellulose, hemicellulose, methyl cellulose, ethyl cellulose, chondroitin sulfate, dextran sulfate, and hyaluronic acid. These polysaccharides are available commercially from sources such as Sigma Chemical Co. (St Louis, Mo.) and Pharmacosmos (Holbaek, Denmark). In some embodiments the polysaccharide is dextran. Typically, polysaccharides are a heterogeneous mixture having a distribution of different molecular weights, and are characterized by an average molecular weight, for example, the weight-average molecular weight (Mw), or the number average molecular weight (Mn), as is known in the art. Suitable polysaccharides have a weight-average molecular weight from about 1,000 to about 1,000,000 Daltons, more particularly from about 3,000 to about 250,000 Daltons, and more particularly from about 8,000 to about 90,000 Daltons. In some embodiments the polysaccharide is dextran having a weight-average molecular weight of about 8,500 to 11,500 Daltons.

The polysaccharide is oxidized to introduce aldehyde groups by reaction with periodate in an aqueous solution using at least one suitable periodate salt, for example, sodium periodate or potassium periodate, as is known in the art (see for example, Mo et al. J. Biomater. Sci. Polymer Edn. 11:341-351, (2000); Halsall et al., J. Chem. Soc. 1947, 1427-1432); Kodokian et al. supra; and Goldmann, supra). The polysaccharide may be reacted with different amounts of periodate to give polysaccharides with different degrees of oxidation and therefore, a different dialdehyde content. Specifically, a polysaccharide is reacted with at least one periodate salt at a temperature above about 10° C. to produce a product comprising a polysaccharide dialdehyde, and iodate in the form of at least one iodate salt. Additionally, if an excess of periodate is used in the reaction, the product will also contain periodate in the form of at least one unreacted periodate salt. The temperature used for the oxidation reaction is typically from about 11° C. to about 70° C., more particularly from about 20° C. to about 60° C. It should be noted that the oxidation reaction is an exothermic process that causes the temperature of the solution to rise. Consequently, the solution may need to be cooled to maintain the desired temperature. The time required for the reaction will vary depending on a number of factors, including the temperature and the concentration of the polysaccharide and periodate used and on the scale and the heat transfer characteristics of the system. Typical reaction times range from about 30 minutes to about 2 hours. In some embodiments an aqueous dextran solution is reacted with an aqueous solution of sodium periodate at a temperature of about 12° C. to 25° C. for a period of about 15 minutes to about 2 hours.

Optionally, the product of the oxidation reaction is cooled to a crystallization temperature below about 5° C., more particularly between about 2° C. and about −8° C. and maintained at a crystallization temperature for a time sufficient to form a precipitate comprising at least one periodate salt and a first supernatant fluid that comprises the polysaccharide dialdehyde. The time required will vary depending on the particular conditions used (e.g., the volume of the product and the temperature), but is typically from about 5 minutes to about 60 minutes. The time is not long enough for the entire product to freeze. This cooling may be carried out in two separate steps wherein the reaction product is rapidly cooled to one crystallization temperature, specifically below about 5° C. for a period of time, typically from about 5 minutes to about 40 minutes, to form the precipitate. Then, the reaction mixture is maintained at a second crystallization temperature, specifically below about 5° C., which is different from the first crystallization temperature, for a time sufficient to crystallize the periodate salt, typically from about 20 minutes to about 55 minutes. This cooling step is optional, but is particularly beneficial when an excess of periodate is used in the oxidation reaction.

Then, at least a portion of the precipitate is separated from the first supernatant fluid using methods known in the art, for example, filtering, decanting, centrifuging, or siphoning off the first supernatant fluid. Ideally, substantially all of the precipitate is separated from the first supernatant fluid.

In the next step, iodate is precipitated out as an insoluble salt by adding a source of at least one cation, which is capable of precipitating at least a portion of the iodate, to the first supernatant fluid thereby forming a second precipitate comprising the cation(s) and iodate, and a second supernatant fluid that comprises the polysaccharide dialdehyde. Ideally, the cation(s) is/are capable of precipitating substantially all of the iodate. The source of the cation(s) is at least one soluble salt comprising a cation that forms a salt with iodate that has a low solubility in aqueous solution. Suitable cations include, but are not limited to, Ca2+, Sr2+, Ba2+, Mn2+, Cu2+, Zn2+, Pb2+, Ag+, Cd2+, and Hg2+. If the polysaccharide dialdehyde is to be used for medical applications, a cation with low toxicity is used, for example, Ca2+, Mn2+, Zn2+, or Cu2+. Suitable soluble salts include, but are not limited to, calcium chloride, calcium acetate, calcium bromide, strontium chloride, strontium acetate, barium chloride, barium acetate, manganese chloride, manganese acetate, cupric chloride, cupric acetate, zinc chloride, zinc acetate, silver nitrate, cadmium chloride, cadmium acetate, lead chloride, lead acetate, mercuric chloride, and mercuric acetate. Examples of soluble salts for the preparation of polysaccharide dialdehydes to be used for medical applications include calcium chloride, calcium acetate, calcium bromide, manganese chloride, manganese acetate, zinc chloride, zinc acetate, cupric chloride, and cupric acetate. In some embodiments the salt is calcium chloride. This step is typically done at room temperature (e.g., 20° C. to 25° C.) for a period of at least about 30 minutes.

Then, at least a portion of the second precipitate is separated from the second supernatant fluid using methods known in the art, for example, filtering, decanting, centrifuging, or siphoning off the second supernatant fluid. Ideally, substantially all of the second precipitate is separated from the second supernatant fluid.

At least one iodide salt is then added to the second supernatant fluid, thereby forming a mixture comprising the polysaccharide dialdehyde and molecular iodine. Any suitable iodide salt may be used including, but not limited to, sodium iodide, potassium iodide, lithium iodide, calcium iodide, or ammonium iodide. In some embodiments the iodide salt is potassium iodide. This step is typically done at room temperature (e.g., 20° C. to 25° C.) for a period of at least about 30 minutes. The mixture is optionally filtered to remove the iodine and obtain a filtrate that comprises the polysaccharide dialdehyde. Alternatively, the iodine may be removed by allowing it to sublime.

Next, the mixture comprising the polysaccharide dialdehyde and molecular iodine or the filtrate that comprises the polysaccharide dialdehyde is added to a solvent at a temperature of about −16.0° C. to about 10° C. at a rate such that the temperature is maintained at about −16.0° C. to about 10° C., thereby forming a first phase comprising the solid polysaccharide dialdehyde and a second phase comprising the solvent and water. Suitable solvents are selected from acetone, methanol, isopropanol, ethanol, n-propanol and mixtures thereof. In some embodiments the solvent is methanol. In some embodiments the mixture comprising the polysaccharide dialdehyde and molecular iodine or the filtrate that comprises the polysaccharide dialdehyde is added to the solvent at a temperature of about 0° C. to about 5° C. at a rate such that the temperature is maintained at about 0° C. to about 5° C.

Then, at least a portion of the first phase comprising the polysaccharide dialdehyde is separated from the second phase comprising the solvent and water at a temperature of about −16.0° C. to about 10° C. to provide a separated polysaccharide dialdehyde using methods known in the art, for example, filtering, decanting, centrifuging, or siphoning off the second supernatant fluid. Ideally, substantially all of the second precipitate is separated from the second supernatant fluid. In some embodiments the first phase is separated from the second phase at a temperature of about 0° C. to about 5° C.

In some embodiments the first phase is separated from the second phase using filtration. The ratio of the volume of the solvent to the volume of the mixture or filtrate used affects the time required in the filtration. Specifically, higher volume ratios of solvent to mixture or filtrate result in shorter filtration times. In some embodiments the volume ratio of solvent to mixture or filtrate is at least 7.0. In some embodiments the volume ratio of solvent to mixture or filtrate is at least 9.0. The optimum ratio to be used for any particular set of conditions may be determined by one skilled in the art using routine experimentation.

The separated polysaccharide dialdehyde is then dissolved in an aqueous liquid to provide a polysaccharide dialdehyde solution. The aqueous liquid may be pure water or comprise a mixture of water and a water-soluble organic solvent such as methanol, ethanol, or isopropanol. If a mixture of water and a water-miscible organic solvent is used, the mixture contains less than or equal to about 50% of the water-miscible organic solvent by volume, more particularly from about 5% to about 50% by volume. In some embodiments the aqueous liquid is water. The amount of aqueous liquid used affects the concentration of iodine and the ash content of the final purified polysaccharide dialdehyde. At higher weight ratios of aqueous liquid to polysaccharide dialdehyde, the polarity of the system increases and more inorganics are removed. A disadvantage of using high weight ratios of aqueous liquid to polysaccharide dialdehyde is that the separation of the product from the water and solvent by filtration requires more time. One of the factors that determines the optimum weight ratio of aqueous liquid to polysaccharide dialdehyde is the amount of iodine in the separated polysaccharide dialdehyde. Specifically, higher weight ratios of aqueous liquid to polysaccharide dialdehyde are typically used with separated polysaccharide dialdehydes having high levels of iodine. The optimum ratio of aqueous liquid to polysaccharide dialdehyde for any particular set of conditions can be readily determined by one skilled in the art using routine experimentation. In some embodiments the weight ratio of aqueous liquid to polysaccharide dialdehyde is at least 3.0. In some embodiments the weight ratio of aqueous liquid to polysaccharide dialdehyde is at least 4.0.

Then the polysaccharide dialdehyde solution is added to a solvent at a temperature of about −16.0° C. to about 10° C. at a rate such that the temperature is maintained at about −16.0 ° C. to about 10° C., thereby forming a first phase comprising a purified polysaccharide dialdehyde and a second phase comprising the solvent and water. This step is the same as that described above with the polysaccharide dialdehyde solution used in place of the mixture comprising the polysaccharide dialdehyde and molecular iodine or the filtrate comprising the polysaccharide dialdehyde. Suitable solvents are listed above. In some embodiments the polysaccharide dialdehyde solution is added to the solvent at a temperature of about 0° C. to about 5° C. at a rate such that the temperature is maintained at about 0° C. to about 5° C. The first phase may be separated from the second phase, as described above. These steps may be repeated one or more times as necessary to obtain a purified polysaccharide dialdehyde having the desired purity. Optionally, the purified polysaccharide dialdehyde may be dried using any suitable method, for example, using heat, vacuum, a combination of heat and vacuum, or flowing a stream of dry air or a dry inert gas such as nitrogen over the purified polysaccharide dialdehyde.

The amount of iodine-containing species remaining in the purified polysaccharide dialdehyde can be determined using methods known in the art. For example, the total amount of elemental iodine in any form remaining in the purified polysaccharide dialdehyde can be determined using inductively coupled plasma mass spectrometry (ICP-MS), as described in General Methods herein below. Typically, the amount of elemental iodine remaining in the polysaccharide dialdehyde produced by the method disclosed herein is less than about 0.03 wt % (300 ppm). The ash content, which is a measure of the total amount of inorganic impurities, in the purified polysaccharide dialdehyde can be determined using methods known in the art. For example, ash content in the purified polysaccharide dialdehyde may be determined using gravimetric methods, as described in General Methods herein below. Typically, the ash content in the polysaccharide dialdehyde produced by the method disclosed herein is less than about 0.6 wt %.

After the purified polysaccharide dialdehyde is recovered and optionally dried, it may be used to prepare hydrogel adhesives for medical applications by reacting it in an aqueous medium with a polyamine having three or more amine groups. For example, the purified polysaccharide dialdehyde may be reacted with a water-dispersible, multi-arm polyether amine to form a hydrogel tissue adhesive as described by Kodokian et al. (copending and commonly owned U.S. Patent Application Publication No. 2006/0078536) or with a polymer having amino groups such as chitosan, as described by Goldmann (U.S. Patent Application Publication No. 2005/0002893). The resulting hydrogel may be used for medical and veterinary applications, including, but not limited to, wound closure, supplementing or replacing sutures or staples in internal surgical procedures such as intestinal anastomosis and vascular anastomosis, tissue repair, ophthalmic procedures, drug delivery, and in anti-adhesive applications.

The disclosures of all cited references are expressly incorporated herein by reference in their entirety. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “h” means hour(s), “sec” means second(s), “mL” means milliliter(s), “L” means liter(s), “μL” means microliter(s), “mol” means mole(s), “mmol” means millimole(s), “g” means gram(s), “kg” means kilogram(s), “mg” means milligram(s), “Pa” means pascal(s), “kPa” means kilopascal(s), “Mw” means weight-average molecular weight, “NMR” means nuclear magnetic resonance spectrometry, “ppm” means parts per million, “nd” means not determined.

### General Methods

The oxidation level of the dextran dialdehyde was determined using proton NMR spectrometry. In the NMR method, the integrals for two ranges of peaks were determined, specifically, —O2CHx- at about 6.2 parts per million (ppm) to about 4.15 ppm (minus the HOD peak) and —OCHx— at about 4.15 ppm to about 2.8 ppm (minus any methanol peak if present). The calculation of oxidation level was based on the calculated ratio (R) for these areas, specifically, R=(OCH)/(O2CH).

$$\% oxidation = 100 - \frac{300 \times ( R - 1 )}{3 + 2 \times R}$$

The iodine level in the dextran dialdehyde was determined using inductively coupled plasma mass spectrometry (ICP-MS). The inductively coupled mass spectrometer (Agilent Model 7500ce) was optimized daily in helium gas mode. Samples were introduced into the instrument using a 100 μL Teflon® PFA nebulizer coupled to a quartz Scott-type spray chamber. The dextran dialdehyde samples were dissolved in dilute ammonia solution. The masses monitored were 127I and 45Sc (internal standard). A standard addition method using standard potassium iodide solutions was used in the analysis to account for potential matrix effects.

The percent ash was determined using a gravimetric method as follows. A known weight of the dextran dialdehyde in a porcelain crucible was heated in a muffle furnace to 540° C. over a 4 hour period and then held there for an additional hour. The sample was cooled to room temperature in a desiccator and then weighed.

### Example 1

### Preparation of Dextran Dialdehyde Having an Average Molecular Weight of 10,000 and an Oxidation Conversion of 50% (D10-50)

This Example demonstrates the preparation of dextran dialdehyde having an average molecular weight of 10,000 Daltons and an oxidation conversion of 50%, referred to herein as D10-50. The total iodine content of the dextran dialdehyde was less than 300 ppm.

To a 200 mL round bottom flask was charged 291 g of sodium periodate. It was attached by way of large bore plastic tubing to a 3-L glass, stirred reactor equipped with baffles. The 200 mL round bottom flask was positioned in a manner such that no sodium periodate could enter the 3-L reactor. To the 3-L reactor was charged 1150 mL of water. With agitation, 269 g of Dextran 10 (average molecular weight 10,000 Daltons, Pharmacosmos, Holbaek, Denmark; Lot #HH4131) was charged into the water and stirred until it was in solution. The 3-L reactor was then submerged in an ice bath to cool the contents to 12.4° C. The 200 mL round bottom flask containing the sodium periodate was then raised enough to allow a small amount of the sodium periodate to flow into the 3-L reactor. The addition was continued in this manner at a rate such that the batch temperature did not exceed 25° C. All of the periodate was added in 43 min. The ice bath was then removed and the batch temperature rose to 17.0° C. during a 37 min hold. Using an ice bath, the contents of the 3-L reactor were chilled to 0.6° C. The solids were then filtered out using a 1-L coarse fritted glass funnel, and the filter cake was washed with 100 mL of water. The filtrate was poured into a clean 3-L reactor and, with agitation, 110.0 g of calcium chloride dihydrate was added. The contents were chilled to 0.7° C. and then stirred for 75 min. The resulting solids were filtered out and the filter cake was rinsed with 100 mL of water. The filtrate was poured into a clean 3-L round bottom flask, to which was added 87.5 g of potassium iodide. The contents were stirred at ambient temperature for 15 min, after which the solids were filtered out and the filtrate was returned to a clean 3-L round bottom flask. In a 5-L flask, 3040 mL of methanol were chilled in an ice bath to 0° C. With the methanol under minimal agitation, ¼ (340 mL) of the aqueous liquid from the 3-L flask was added to the methanol at a rate such that the combined mixture temperature rose to a maximum of 2.8° C. Agitation was set at 80 rpm to maintain the suspension. After stirring for 18 min, the slurry was poured rapidly into a 2-L coarse fritted glass filter that had been cooled in dry ice. The resulting filter cake was slurried with two, 500 mL aliquots of room temperature methanol. Air was pulled through the cake at room temperature until liquid stopped dripping from the cake. The product separation step was repeated 3 more times (340 mL each time) with the remaining aqueous liquid from the 3-L flask to finish recovery of the crude dextran dialdehyde.

The combined filter cake was dried at room temperature under 20 inches Hg (68 kPa) vacuum overnight. To reduce the iodine and ash content, 310 g of wet filter cake were dissolved in 1050 mL of room temperature de-ionized water. The precipitation and product recovery were done in the same manner as described above by adding ¼ (340 mL) of the aqueous solution to 3000 mL of methanol held at 0-5° C. The 4 resulting filter cakes were dried overnight at room temperature and at 20 inches of Hg (68 kPa) vacuum. They were then dried at 60° C. at 20 inches of Hg vacuum for 24 hours. The yields (i.e., the weight of product obtained) and specifications for the 4 aliquots are given in Table 1.

TABLE 1
Yield and Specifications of Dextran Dialdehyde D10-50

| Sample No. | Yield (g) | Iodine (ppm) | % Ash | % Oxidation |
|---|---|---|---|---|
| 1 | 54.1 | 245 | 0.25 | 54.0 |
| 2 | 49.0 | 133 | 0.14 | nd |
| 3 | 56.2 | 253 | 0.16 | 54.0 |
| 4 | 40.5 | 228 | 0.15 | nd |

### Example 2 Comparative

### Preparation of Dextran Dialdehyde Having an Average Molecular Weight of 10,000 Using the Method of WO 2008/133847

This comparative Example demonstrates the processing difficulties associated with the method for preparing an oxidized polysaccharide having high purity that is described by Cohen et al. (copending and commonly owned International Patent Application Publication No. WO 2008/133847).

A slurry of 10.0 g of sodium periodate in 45 mL of water was stirred at 20-25° C. for 30 min. A solution of 10.0 g of Dextran 10 (Pharmacosmos, Lot #HH4131) in 23 mL of water was prepared and stirred for 30 min at 20-25° C. This aqueous solution was cooled to 10-15° C. with an ice bath and the sodium periodate/water slurry was added dropwise to it. A mild exotherm was observed and, upon completion of the addition, the reaction mixture became a solution. The reaction mixture was removed from the ice bath and was allowed to warm slowly to 20-25° C. After 10 min of stirring, white solids began to precipitate. The reaction mixture was stirred overnight. The solids were then filtered and washed with minimal water and the filtrate was placed in a clean flask. To the flask was added 4.4 g of calcium chloride dehydrate. The resulting slurry was stirred for 30 min. The resulting solids were filtered and washed with a minimal amount of water. The filtrate was placed in a clean flask. To this solution was added 3.5 g of potassium iodide. The resulting mixture was stirred for 30 min at 20-25° C., after which time, the reaction mixture was split into 2 portions. The first was added to 135 mL of acetone held at 20-25° C. over a 10 min period. A gummy, rubbery material formed. The liquid was decanted off leaving one piece of rubber. The rubber was chopped into medium sized pieces and slurried at 0-5° C. in 40% methanol/water. However, Its physical form did not change. The other half of the aqueous mixture was added to 135 mL of acetone heated to 60-65° C. over 10 min to yield the same result. The rubbery material was difficult to process further.

### Example 3

### Preparation of Dextran Dialdehyde Using Different Organic Solvents

The purpose of this Example was to investigate the suitability of various organic solvents in the process for making a polysaccharide dialdehyde according to the method disclosed herein.

### Preparation of Crude Dextran Dialdehyde D10-50

To a 100-mL round bottom flask was charged 50 g of sodium periodate. The flask was attached by way of large bore plastic tubing to a 1-L glass, stirred reactor equipped with baffles. The 100-mL round bottom flask was positioned in a manner such that no sodium periodate could enter the 1-L reactor. To the 1-L reactor was charged 115 mL of water. With agitation, 50 g of Dextran 10 (Pharmacosmos; Lot #HH4131) was charged into the water and stirred until it was in solution. The 1-L reactor was then submerged in an ice bath to cool the contents to 8° C. The 100-mL round bottom flask containing the sodium periodate was then raised enough to allow a small amount of sodium periodate to flow into the 1-L reactor. The addition was continued at a rate such that the reactor temperature did not exceed 25° C. All of the periodate was added in 30 min. The ice bath was then removed and the batch temperature was allowed to rise for 44 min. Using an ice bath, the contents of the 1-L reactor were chilled to 1.4° C. The solids were then filtered out using a 0.3-L coarse fritted glass funnel. The filter cake was washed with 20 mL water and the filtrate was poured into a clean 1-L reactor. With agitation, 22.0 g of calcium chloride dihydrate was added to the reactor. The contents were chilled to 1.5° C. and stirred for 11 min. The solids were filtered out using a 0.3-L coarse fritted glass funnel. The filter cake was rinsed with 20 mL of water and the filtrate was poured into a clean 1-L round bottom flask, which was stirred and cooled to 1.5° C. The resulting aqueous mixture was then poured, over a 10 sec period, into 1370 mL of methanol that had been chilled to 1.8° C. The mixture temperature rose to 3.2° C. The mixture was cooled in an ice bath with agitation to 0.1° C. After 20 min, the solid product was recovered using a 0.6-L coarse fritted glass funnel that had been chilled to dry ice temperature. The initial separation took 4 min. It was followed by 3 reslurries using 250 mL of cold methanol. The reslurries required 6 min to complete. The powder product was dried for 2 days at room temperature in a vacuum oven held at 20 inches Hg (68 kPa). The yield was 43.3 g and the % ash was 1.67.

### Testing of Solvents

Alternative solvents (see Table 2) were evaluated using the crude D10-50 as follows. In a 20 mL vial, 1.0 g of product was dissolved in 3.0 mL of water. The resulting solution was poured into 30 mL of each of the solvents, held at 0-5° C.

TABLE 2
Results with Different Organic Solvents

| Sample No. | Solvent | Precipitate Form |
|---|---|---|
| 1 | Acetonitrile | Gelatinous lump |
| 2 | Methanol | Coarse particles |
| 3 | Isopropanol | Hard, friable lump |
| 4 | Tretrahydrofuran | Lump |

The results indicate that methanol and isopropanol are suitable organic solvents for use in the method disclosed herein because they did not lead to the formation of a gelatinous precipitate.

### Example 4

### Preparation of Dextran Dialdehyde Using Isopropanol as Organic Solvent

This Example demonstrates the preparation of dextran dialdehyde having an average molecular weight of 10,000 Daltons and an oxidation conversion of 50% using isopropanol as organic solvent in the precipitation of the dextran dialdehyde.

The procedure used was the same as that described in Example 3, except that methanol was replaced with isopropanol (IPA). Specifically, the aqueous mixture containing the dextran dialdehyde (i.e., the filtrate obtained after addition of the calcium chloride dihydrate) was dripped into isopropanol at a temperature of 0-5° C. over a 13 min period. The final slurry temperature was 0.8° C. After stirring for 4 min, part of the slurry was poured into a room temperature 0.6-L coarse glass fritted funnel. A glassy layer formed on the frit and blocked it. The funnel contents were poured back into the reactor and the filter funnel was cleaned and then chilled to dry ice temperature. The second filtration, completed with 4 reslurries done with 250 ml aliquots of cold isopropanol, took 6 min. The yield was 48.0 grams of crude dextran D10-50 as coarse dense particles. The product was dried for several hours at room temperature and 20 inches of Hg (68 kPa) vacuum and then at 60° C. for 3 days at 20 inches Hg vacuum. The ash content was 18.26%.

A 5-g aliquot of the crude dextran D10-50 was dissolved in water in the proportions shown in Table 3. The aqueous solution was then dumped rapidly into stirred isopropanol that was held at 0° C. The resulting slurry temperatures did not exceed 4° C. Due to the resulting small particle size, the solids were recovered using a 600 mL medium frit glass funnel that had been chilled in dry ice.

TABLE 3
Reprecipitation of Dextran D10-50 with Isopropanol

| | Volume | | Filtration | | |
|---|---|---|---|---|---|
| Sample | Water | Volume | Time | Percent | Percent |
| No. | (mL) | IPA (mL) | (min) | Recovered | Ash |
| 1 | 15 | 135 | 2 | 88.6 | 6.52 |
| 2 | 55 | 495 | 48 | 55.8 | 3.18 |
| 3 | 35 | 315 | 24 | 53.6 | 4.56 |

### Example 5

### Effect of Temperature on Precipitation of Dextran Dialdehyde from Aqueous/Methanol Slurry

This Example demonstrates the effect of temperature on the precipitation of dextran dialdehyde from aqueous/methanol slurries in the method disclosed herein.

Crude dextran dialdehyde D10-50 was made according to the method described in Example 3. In 3 separate 100-mL round bottom stirred flasks, 4.0 g of the D10-50 was dissolved in 16 mL of water. In 3 separate 250-mL round bottom stirred flasks, 144 mL of methanol was conditioned to temperatures of −50° C., −16.2° C., and 22° C. The aqueous solutions were added to the methanol according to the schedule given in Table 4 to achieve the maximum slurry temperature listed.

TABLE 4
Effect of Temperature on Precipitation of Dextran Dialdehyde

| Methanol | | Maximum | |
|---|---|---|---|
| Temperature | Addition Time | Temperature | Precipitate |
| (° C.) | (min) | (° C.) | Form |
| −50 | 0.75 | −35.6 | gelatinous lump |
| −16.2 | 5 | −12.6 | small particles |
| 22 | 8 | 22 | gelatinous mass |

The results shown in Table 4 indicate that the temperature of the precipitation step was important in obtaining a physical form that was readily separated by filtration. A temperature of −50° C. and a temperature of 22° C. resulted in gelatinous precipitates which would be difficult to recover in filtration equipment. A temperature of −16.2° C. gave a precipitate of small particles which blocked the filter and increased the filtration time relative to that seen for the material precipitated at 0-5° C. (Example 1).

### Example 6

### Effect of Water to Dextran Dialdehyde Weight Ratio on Iodine and Ash Content

This Example demonstrates the effect of the water to dextran dialdehyde weight ratio in the precipitation of the dextran dialdehyde in the method disclosed herein on the iodine and ash content of the final dextran dialdehyde product.

A single batch of crude dextran dialdehyde D10-50 with an iodine content of 8140 ppm and an ash content of 0.29 wt % was used. The D10-50 was prepared as described in Example 3, with the exception that the methanol, chilled to 0.8° C., was added rapidly to the aqueous solution. The slurry temperature rose to 4.5° C. Some gelatinous lumps formed and never fully dispersed. Due to this poor dispersion of the solids in the liquid phase, the crude product had an unusually high iodine content.

For this reprecipitation step, the water to methanol volume ratio was held constant at 9. The methanol was held at 0° C. and the aqueous solutions were dumped into the methanol over a 10 sec period with agitation. The first 4 samples were filtered using a 150-mL coarse fritted glass filter that had been chilled to dry ice temperature. Because of losses through the filter as the water content increased, the 5th sample was recovered using a 350-mL medium fritted glass filter chilled to dry ice temperature. The water to D10-50 weight ratios used and the results are given in Table 5.

TABLE 5
Effect of Water to Dextran Dialdehyde Weight Ratio

| | Water/Dextran | | | |
|---|---|---|---|---|
| | dialdehyde | Filtration | Weight % | Iodine |
| Sample | Weight Ratio | Time (min) | Ash | (ppm) |
| 1 | 3 | 2 | 0.20 | 820 |
| 2 | 5 | 4 | 0.16 | 439 |
| 3 | 7 | 18 | 0.13 | 260 |
| 4 | 9 | 54 | nd | 178 |
| 5 | 11 | 20* | 0.12 | 171 |

*Filtered using a 350 mL-medium fritted glass filter.

The results shown in Table 5 indicate that as the water to dextran dialdehyde weight ratio increased, the filtration time increased but the concentration of iodine and the percent ash in the product decreased. At higher weight ratios of water to dextran dialdehyde, the polarity of the system increases and more inorganics are removed. The disadvantage of using high weight ratios of water to dextran dialdehyde is that the separation of the product from the water and methanol by filtration required more time. To achieve less than 300 ppm of iodine in the final product after starting with a crude D10-50 which contained 8140 ppm iodine, a water to dextran dialdehyde ratio of 7 was required. This ratio will depend on the initial iodine content of the crude D10-50. For crude D10-50 prepared according to Example 3, a ratio of water to crude D10-50 of 3-4 in the reprecipitation step yielded product with an iodine content of less than 300 ppm, as shown in Example 1.

### Example 7

### Effect of Methanol to Water Volume Ratio on Filtration Time

This Example demonstrates the effect of the methanol to water volume ratio in the precipitation of the dextran dialdehyde in the method disclosed herein on filtration time.

A series of experiments was done using the method described in Example 3 in which 50 or 100 g of Dextran 10, as given in Table 6, was converted to dextran dialdehyde D10-50. The variable tested was the volume ratio of methanol to aqueous solution used during the initial precipitation of the dextran dialdehyde. The effect considered was the time it took for the filtration. The results are summarized in Table 6.

TABLE 6
Effect of Methanol to Water Volume Ratio on Filtration Time

| Methanol/Water | | Filtration Time |
|---|---|---|
| Volume Ratio | Scale (g, Dextran 10) | (min) |
| 5.1 | 50 | 60 |
| 6.5 | 50 | 30 |
| 6.0 | 50 | 30 |
| 7.0 | 50 | 15 |
| 7.0 | 50 | 15 |
| 7.64 | 50 | 2 |
| 7.62 | 100 | 6 |

The results shown in Table 6 indicate that the time to filter is a strong function of the methanol/water volume ratio used. Specifically, higher volume ratios of methanol to water during the initial precipitation step resulted in shorter filtration times.

What is claimed is:

1. A method for making a polysaccharide dialdehyde comprising the steps of:
a) reacting a polysaccharide with at least one periodate salt at a temperature above about 10° C. to produce a product comprising said polysaccharide dialdehyde, iodate in the form of at least one iodate salt, and optionally periodate in the form of at least one unreacted periodate salt;
b) optionally cooling the product of step (a) to a crystallization temperature below about 5° C. and maintaining the product at the crystallization temperature for a time sufficient to form a precipitate comprising at least one periodate salt, and a first supernatant fluid,
c) optionally separating at least a portion of the precipitate from the first supernatant fluid;
d) adding a source of at least one cation, which is capable of precipitating at least a portion of the iodate, to the product of (a) or the first supernatant fluid of (b) or (c) thereby forming a second precipitate comprising said at least one cation and iodate, and a second supernatant fluid that comprises the polysaccharide dialdehyde;
e) separating at least a portion of the second precipitate from the second supernatant fluid;
f) adding at least one iodide salt to the second supernatant fluid thereby forming a mixture comprising the polysaccharide dialdehyde and molecular iodine;
g) optionally filtering the mixture to obtain a filtrate;
h) adding the mixture of (f) or the filtrate of (g) to a solvent selected from the group consisting of acetone, methanol, isopropanol, ethanol, n-propanol and mixtures thereof at a temperature of about −16° C. to about 10° C. at a rate such that the temperature is maintained at about −16° C. to about 10° C., thereby forming a first phase comprising the polysaccharide dialdehyde and a second phase comprising the solvent and water;
i) separating at least a portion of the first phase from the second phase at a temperature of about −16° C. to about 10° C. to provide a separated polysaccharide dialdehyde;
j) dissolving the separated polysaccharide dialdehyde in an aqueous liquid to provide a polysaccharide dialdehyde solution;
k) adding the polysaccharide dialdehyde solution to a solvent selected from the group consisting of acetone, methanol, isopropanol, ethanol, n-propanol and mixtures thereof at a temperature of about −16° C. to about 10° C. at a rate such that the temperature is maintained at about −16° C. to about 10° C., thereby forming a first phase comprising a purified polysaccharide dialdehyde and a second phase comprising the solvent and water; and
l) separating at least a portion of the first phase from the second phase of (k) at a temperature of about −16° C. to about 10° C. to provide a separated purified polysaccharide dialdehyde.

2. The method according to claim 1 further comprising:
repeating steps (j), (k) and (l) one or more times using the separated purified polysaccharide dialdehyde in place of the separated polysaccharide dialdehyde.

3. The method according to claim 1 wherein the polysaccharide is selected from the group consisting of dextran, starch, cellulose, hemicellulose, methyl cellulose, ethyl cellulose, chondroitin sulfate, dextran sulfate, and hyaluronic acid.

4. The method according to claim 3 wherein the polysaccharide is dextran.

5. The method according to claim 1 wherein the source of at least one cation in step (b) is at least one soluble salt comprising a cation selected from the group consisting of Ca2+, Sr2+, Ba2+, Mn2+, Cu2+, Zn2+, Pb2+, Ag+, Cd2+, and Hg2+.

6. The method according to claim 5 wherein the at least one soluble salt is selected from the group consisting of calcium chloride, calcium acetate, calcium bromide, strontium chloride, strontium acetate, barium chloride, barium acetate, manganese chloride, manganese acetate, cupric chloride, cupric acetate, zinc chloride, zinc acetate, silver nitrate, cadmium chloride, cadmium acetate, lead chloride, lead acetate, mercuric chloride, and mercuric acetate.

7. The method according to claim 6 wherein the at least one soluble salt is calcium chloride.

8. The method according to claim 1 wherein the at least one iodide salt of (f) is selected from the group consisting of sodium iodide, potassium iodide, lithium iodide, calcium iodide, and ammonium iodide.

9. The method according to claim 8 wherein the at least one iodide salt is potassium iodide.

10. The method according to claim 1 wherein the mixture of (f) or the filtrate of (g) is added to the solvent in step (h) in an amount sufficient to give a final volume ratio of solvent to mixture of (f) or filtrate of (g) of at least 7.0.

11. The method according to claim 1 wherein the polysaccharide dialdehyde solution is added to the solvent in step (k) in an amount sufficient to give a final volume ratio of solvent to polysaccharide dialdehyde solution of at least 7.0.

12. The method according to claim 1 wherein the mixture of (f) or the filtrate of (g) is added to the solvent in step (h) at a temperature of about 0° C. to about 5° C. at a rate such that the temperature is maintained at about 0° C. to about 5° C.

13. The method according to claim 1 wherein the polysaccharide dialdehyde solution is added to the solvent in step (k) at a temperature of about 0° C. to about 5° C. at a rate such that the temperature is maintained at about 0° C. to about 5° C.

14. The method according to claim 1 wherein the separated polysaccharide dialdehyde is dissolved in a sufficient amount of the aqueous liquid in step (j) to give a weight ratio of aqueous liquid to polysaccharide dialdehyde of at least 4.0.

15. The method according to claim 1 wherein the separated polysaccharide is dissolved in a sufficient amount of the aqueous liquid in step (j) to give a weight ratio of aqueous liquid to polysaccharide dialdehyde of at least 3.0.

16. The method according to claim 1 wherein the separating of step (i) is done by filtration.
